(19) United States
(12) Patent Application Publication
(10) Pub. No.: US 2009/0127201 A1
(43) Pub. Date: May 21, 2009

(54) Process and Apparatus for Removing Hydrogen Peroxide

(75) Inventor: Hideki Kobayashi, Saitama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KURITA WATER INUSTRIES LTD., SHINJUKU-KU, TOKYO (JP)

(21) Appl. No.: 12/087,356

(22) PCT Filed: Jan. 11, 2007
(86) PCT No.: PCT/JP2007/050642

§ 371 Date: Jul. 2, 2008

(30) Foreign Application Priority Data
Jan. 12, 2006 (JP) 2006-004844

(51) Int. Cl. B01J 29/04; C02F 1/00

(52) U.S. Cl. 210/668; 210/749; 210/506; 210/263; 210/188; 977/903

(57) ABSTRACT

A process for removing hydrogen peroxide in water which comprises bringing water for treatment containing hydrogen peroxide into contact with a catalyst for decomposing hydrogen peroxide obtained by depositing nano-colloid particles of a metal of a platinum group which have an average diameter of 1 to 50 nm to be supported on a support; and an apparatus for removing hydrogen peroxide which comprises an apparatus for decomposing hydrogen peroxide packed with a catalyst obtained by depositing nano-colloid particles of a metal of a platinum group which have an average diameter of 1 to 50 nm to be supported on a support, a means for supplying water which supplies water for treatment containing hydrogen peroxide to the apparatus and a means for discharging water which discharges the water from the apparatus after being brought into contact with the catalyst. Hydrogen peroxide in water for treatment can be removed rapidly and surely. The process and the apparatus are suitable for removing hydrogen peroxide in ultrapure water in an apparatus for producing ultrapure water used in industries handling electronic materials such as semiconductors and liquid crystals.

### TECHNICAL FIELD

The present invention relates to a process for removing hydrogen peroxide and an apparatus for removing hydrogen peroxide. More particularly, the present invention relates to a process for removing hydrogen peroxide and an apparatus for removing hydrogen peroxide, which can rapidly and surely remove hydrogen peroxide in water for treatment and, in particular, are suitable for removing hydrogen peroxide in ultrapure water in an apparatus for producing ultrapure water used in industries handling electronic materials such as semiconductors and liquid crystals.

### BACKGROUND ART

Removal of hydrogen peroxide in water for treatment has been conducted in accordance with a process in which a reducing agent is added to water, a process in which water is brought into contact with active charcoal or a process in which water is brought into contact with a resin supporting a metal. In the process in which a reducing agent is added to water, a reducing agent such as sodium sulfite, sodium hydrogensulfite and sodium thiosulfate is added to the water for treatment containing hydrogen peroxide. Although the rate of the reaction between the reducing agent and hydrogen peroxide is very great and hydrogen peroxide can be decomposed and removed surely, it is necessary that the reducing agent be added in an excess amount to remove hydrogen peroxide surely since controlling the amount of the added reducing agent is difficult, and the reducing agent left remaining causes problems. Moreover, in an apparatus for producing ultrapure water, the reducing agent increases the amount of ions in the liquid, and there is the possibility that the quality of water is adversely affected. Therefore, the process in which a reducing agent is added cannot be actually applied to the apparatus for producing ultrapure water.

In the process in which water is brought into contact with active charcoal, a vessel is packed with active charcoal, and water is passed through the vessel. The space velocity (SV) is at most 20 h⁻¹ since the rate of the reaction is small, and the apparatus has a great size. Moreover, active charcoal itself is decomposed while hydrogen peroxide is decomposed. Particles of active charcoal are broken, and the formed debris are mixed into the treated water. Therefore, this process is not suitable for the application to the apparatus for producing ultrapure water.

As for the process in which water is brought into contact with a resin supporting a metal, for example, as the process for rapidly and surely removing hydrogen peroxide in accordance with simple operations without increasing the amount of ions in the water for treatment and without causing growth of microbes, a process for removing hydrogen peroxide in which a liquid containing hydrogen peroxide is brought into contact with a palladium catalyst supported on an anion exchange resin of the OH type is proposed (Patent Reference 1). In accordance with this process, hydrogen peroxide is decomposed by the reaction of 2H₂O₂→2H₂O+O₂. However, the specific surface area of the supported catalyst is small, and the efficiency of contact is small. As the result, the reaction rate is small, and a great amount of the resin supporting the catalyst is necessary for surely achieving the treatment. Since the space velocity (SV) is small, elution of palladium tends to take place.

[Patent Reference 1] Japanese Patent Application Publication No. Showa 62 (1987)-35838

### DISCLOSURE OF THE INVENTION

The present invention has an object of providing a process for removing hydrogen peroxide and an apparatus for removing hydrogen peroxide, which can rapidly and surely remove hydrogen peroxide in water for treatment and, in particular, are suitable for removing hydrogen peroxide in ultrapure water in an apparatus for producing ultrapure water used in industries handling electronic materials such as semiconductors and liquid crystals.

As the result of intensive studies by the present inventors to achieve the above object, it was found that, when water for treatment containing hydrogen peroxide was brought into contact with a catalyst obtained by depositing fine particles of a metal of the platinum group in the form of a nano-colloid to be supported on a support, the reaction rate was very great, the space velocity (SV) could be increased, the effect of elution of the metal was decreased since the amount the liquid passed through the apparatus was great, the required amount of the catalyst could be decreased, and the cost of the treatment could be decreased.

The present invention was completed based on the knowledge.

The present invention provides:

(1) A process for removing hydrogen peroxide in water which comprises bringing water for treatment containing hydrogen peroxide into contact with a catalyst for decomposing hydrogen peroxide obtained by depositing nano-colloid particles of a metal of a platinum group which have an average diameter of 1 to 50 nm to be supported on a support;
(2) The process for removing hydrogen peroxide described in (1), wherein the metal of a platinum group is platinum, palladium or a platinum/palladium alloy, which is used singly or as a mixture of two or more;
(3) The process for removing hydrogen peroxide described in (1), wherein the support which supports the nano-colloid particles of a metal of a platinum group is an anion exchange resin;
(4) The process for removing hydrogen peroxide described in (1), wherein the water for treatment containing hydrogen peroxide is water containing hydrogen peroxide in an apparatus for producing ultrapure water;
(5) The process for removing hydrogen peroxide described in (4), wherein the water containing hydrogen peroxide in an apparatus for producing ultrapure water is water discharged from an apparatus for oxidizing treatment with ultraviolet light of the apparatus for producing ultrapure water;
(6) The process for removing hydrogen peroxide described in (1), wherein the water for treatment is brought into contact with the catalyst for decomposing hydrogen peroxide obtained by depositing nano-colloid particles of a metal of a platinum group to be supported on a support at a flow rate such that a space velocity SV is 100 to 2,000 h⁻¹
(7) The process for removing hydrogen peroxide described in any one of (1) to (6), wherein a concentration of hydrogen peroxide in treated water is 5 ppb by weight or smaller;
(8) The process for removing hydrogen peroxide described in any one of (1) to (7), wherein dissolved oxygen formed by decomposition of hydrogen peroxide is removed by treatment of degassing with a membrane or by treatment with a deoxygenation catalyst in a later step;
(9) The process for removing hydrogen peroxide described in (8), wherein hydrogen is added to the deoxygenation catalyst;
(10) The process for removing hydrogen peroxide described in any one of (8) and (9), wherein a concentration of dissolved oxygen in treated water obtained after the treatment for removing dissolved oxygen is 5 ppb by weight or smaller; and
(11) An apparatus for removing hydrogen peroxide which comprises an apparatus for decomposing hydrogen peroxide packed with a catalyst obtained by depositing nano-colloid particles of a metal of a platinum group which have an average diameter of 1 to 50 nm to be supported on a support, a means for supplying water which supplies water for treatment containing hydrogen peroxide to the apparatus and a means for discharging water which discharges water from the apparatus after being brought into contact with the catalyst.

Preferable embodiments of the present invention include:

(12) An apparatus for removing hydrogen peroxide described in (11), wherein the metal of a platinum group is platinum, palladium or a platinum/palladium alloy, which is used singly or as a mixture of two or more;
(13) An apparatus for removing hydrogen peroxide described in (11), wherein the support which supports the nano-colloid particles of a metal of a platinum group is an anion exchange resin;
(14) An apparatus for removing hydrogen peroxide described in (11), wherein the apparatus for decomposing hydrogen peroxide is disposed immediately after an apparatus for oxidizing treatment with ultraviolet light of an apparatus for producing ultrapure water;
(15) An apparatus for removing hydrogen peroxide described in (11), wherein an apparatus for removing dissolved oxygen which removes oxygen formed by decomposition of hydrogen peroxide is disposed after the apparatus for decomposing hydrogen peroxide;
(16) An apparatus for removing hydrogen peroxide described in (15), wherein the apparatus for removing dissolved oxygen is an apparatus for degassing with a membrane or an apparatus for deoxygenating with a catalyst;
(17) An apparatus for removing hydrogen peroxide described in (16), wherein the apparatus for deoxygenating with catalyst is an apparatus packed with an anion exchange resin supporting platinum, palladium or a platinum/palladium alloy, which is used singly or as a mixture of two or more; and
(18) An apparatus for removing hydrogen peroxide described in (15), wherein the apparatus for removing dissolved oxygen is disposed before a polisher.

### BRIEF DESCRIPTION OF THE DRAWINGS

FIG. 1 shows a diagram exhibiting an embodiment of the apparatus of the present invention.

FIG. 2 shows a process flow diagram exhibiting an embodiment of the process of the present invention.

FIG. 3 shows a diagram exhibiting the relation between the space velocity of water and the fraction of removed hydrogen peroxide. In the Figures, reference numerals mean as follows: 1: a holding plate, 2: a catalyst, 3: an apparatus for decomposing hydrogen peroxide, 4: a pipe for supplying water, 5: a pipe for discharging water, 6: an apparatus for a pretreatment, 7: an apparatus for producing primary pure water, 8: an apparatus for producing a secondary pure water, 9: a tank for primary pure water, 10: a pump, 11: a heat exchanger, 12: an apparatus for the oxidizing treatment with ultraviolet light, 13: an apparatus for decomposing hydrogen peroxide, 14: an apparatus for removing dissolved oxygen, 15: a polisher, and 16: an apparatus for separating fine particles with a membrane.

### THE MOST PREFERRED EMBODIMENT TO CARRY OUT THE INVENTION

The process for removing hydrogen peroxide in water of the present invention comprises bringing water for treatment containing hydrogen peroxide into contact with a catalyst for decomposing hydrogen peroxide obtained by depositing nano-colloid particles of a metal of the platinum group which have an average diameter of 1 to 50 nm to be supported on a support. The apparatus for removing hydrogen peroxide comprises an apparatus for decomposing hydrogen peroxide packed with a catalyst obtained by depositing nano-colloid particles of a metal of a platinum group which have an average diameter of 1 to 50 nm to be supported on a support, a means for supplying water which supplies water for treatment containing hydrogen peroxide to the apparatus and a means for discharging water which discharges water from the apparatus after being brought into contact with the catalyst.

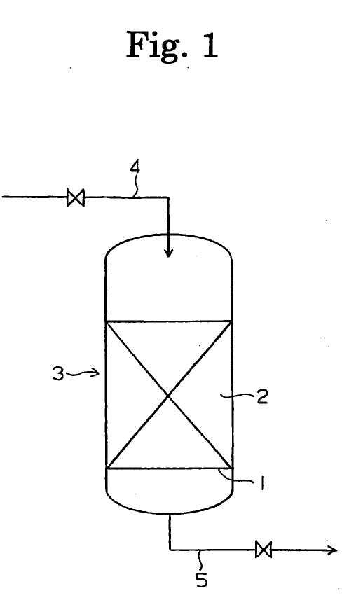

FIG. 1 shows a diagram exhibiting an embodiment of the apparatus of the present invention. The apparatus for removing hydrogen peroxide of the present embodiment comprises an apparatus for decomposing hydrogen peroxide 3 which is packed with a catalyst 2 obtained by depositing nano-colloid particles of a metal of the platinum group which have an average diameter of 1 to 50 nm to be supported on a support, the catalyst being placed on a holding plate 1, a pipe for supplying water 4 which supplies water for treatment containing hydrogen peroxide to the apparatus and a pipe for discharging water 5 which discharges the water from the apparatus after being brought into contact with the catalyst.

The water for treatment containing hydrogen peroxide which is applied to the process and the apparatus of the present invention is not particularly limited. Examples of the water for treatment include treated water or waste water obtained after oxidation, reduction, sterilization or cleaning by adding hydrogen peroxide to a system of supplied water or a system of waste water, treated water obtained from waste water of cleaning discharged from a process for producing semiconductors after oxidation and decomposition of organic substances by irradiation with ultraviolet light in the presence of hydrogen peroxide so that the waste water is recovered and reused as ultrapure water, and ultrapure water containing a very small amount of hydrogen peroxide which is used in a process for producing semiconductors. The process and the apparatus of the present invention can be advantageously applied to removal of a very small amount of hydrogen peroxide in ultrapure water used in industries handling electronic materials such as semiconductors and liquid crystals among the above waters. In accordance with the process of the present invention and by using the apparatus of the present invention, hydrogen peroxide in the water for treatment can be removed rapidly and surely using a small amount of a catalyst for decomposition of hydrogen peroxide.

Examples of the metal of the platinum group include ruthenium, rhodium, palladium, osmium, iridium and platinum. The metal of the platinum group can be used singly, in combination of two or more or as an alloy of two or more. A product obtained by purifying a naturally produced mixture may be used without isolating the component metals. Among these metals, platinum, palladium and platinum/palladium alloys used singly or as a mixture of two or more are preferable due to the great catalytic activity.

The process for producing the nano-colloid particles of a metal of the platinum group used in the present invention is not particularly limited. For example, the process of reduction with a metal salt and the process of burning can be used. Between these processes, the process of reduction with a metal salt is preferable since the production is easy and nano-colloid particles of a metal having stable quality can be obtained. In the process of reduction with a metal salt, for example, nano-colloid particles of a metal can be produced by adding a reducing agent such as an alcohol, citric acid, a salt of citric acid, formic acid, acetone and acetaldehyde to a 0.1 to 0.4 mmole/liter aqueous solution of chloride, nitrate, sulfate or a complex compound of platinum or the like in an amount such that the amount by equivalent of the reducing agent is 4 to 20 times the amount by equivalent of the metal, followed by boiling the obtained mixture for 1 to 3 hours. Nano-colloid particles of platinum can be produced, for example, by dissolving hexachloroplatinic acid or potassium hexachloroplatinate into an aqueous solution of polyvinyl-pyrrolidone to form a solution having a concentration of 1 to 2 mmole/liter, followed by adding a reducing agent such as ethanol and then by heating the resultant mixture under the refluxing condition for 2 to 3 hours under the atmosphere of nitrogen.

The average diameter of the nano-colloid particles of a metal of the platinum group used in the present invention is 1 to 50 nm, preferably 1.2 to 20 nm and more preferably 1.4 to 5 nm. When the average diameter of the nano-colloid particles of the metal is smaller than 1 nm, there is the possibility that the catalytic activity for decomposing and removing hydrogen peroxide decreases. When the average diameter of the nano-colloid particles of the metal exceeds 50 nm, the specific surface area of the nano-colloid particles is small, and there is the possibility that the catalytic activity for decomposing and removing hydrogen peroxide decreases.

In the present invention, the support for supporting the nano-colloid particles of a metal of the platinum group is not particularly limited. Examples of the support include magnesia, titania, alumina, silica-alumina, zirconia, active charcoal, zeolite, diatomaceous earth and ion exchange resins. Among these supports, anion exchange resins are preferable. Since the nano-colloid particles of a metal of the platinum group have an electric double layer and are negatively charged, the nano-colloid particles are supported on an anion exchange resin with stability and are not easily cleaved. The nano-colloid particles of a metal of the platinum group supported on an anion exchange resin exhibits strong catalytic activity to decomposition and removal of hydrogen peroxide. As the anion exchange resin used in the present invention, strongly basic anion exchange resins based on a styrene-divinylbenzene copolymer are preferable, and resins of the gel type are more preferable. It is preferable that the exchange group in the anion exchange resin is a group of the OH type. In the anion exchange resin of the OH type, the surface of the resin is alkaline, and decomposition of hydrogen peroxide is accelerated.

In the present invention, it is preferable that the amount of the nano-colloid particles of a metal of the platinum group supported on the anion exchange resin is 0.01 to 0.2% by weight and more preferably 0.04 to 0.1% by weight. When the amount of the supported nano-colloid particles of the metal is less than 0.01% by weight, there is the possibility that the catalytic activity for decomposition and removal of hydrogen peroxide is insufficient. The sufficient catalytic activity is exhibited to decomposition of hydrogen peroxide when the amount of the supported nano-colloid particles of the metal is 0.2% by weight or less and, in general, it is not necessary that nano-colloid particles of the metal is supported in an amount exceeding 0.2% by weight. The possibility of elution of the metal into water increases when the amount of the supported nano-colloid particles of the metal increases.

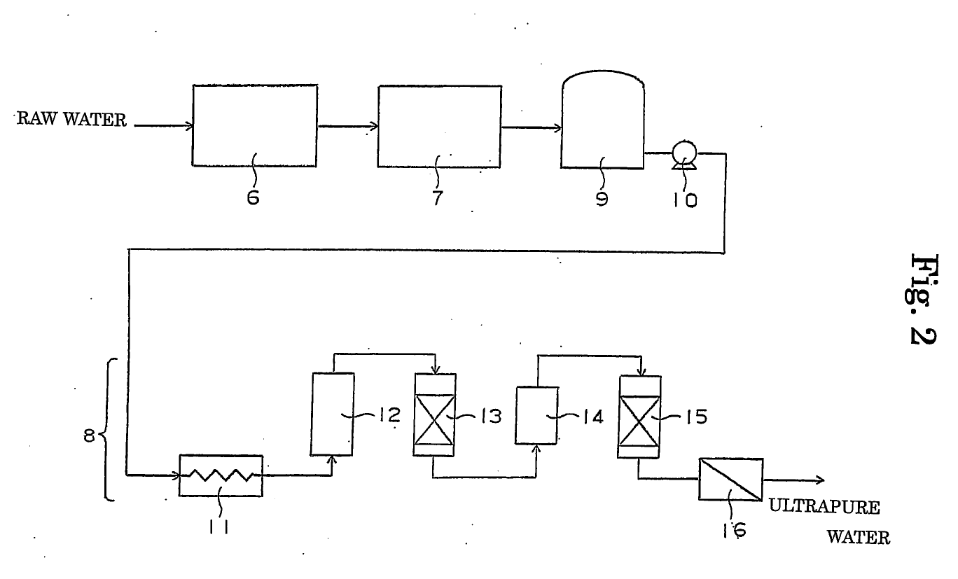

The process for removing hydrogen peroxide of the present invention can be advantageously applied to water containing hydrogen peroxide in an apparatus for producing ultrapure water and, in particular, to water containing hydrogen peroxide which is discharged from an apparatus for the oxidizing treatment with ultraviolet light of an apparatus for producing ultrapure water. FIG. 2 shows a process flow diagram exhibiting an embodiment of the process of the present invention. In the apparatus for producing ultrapure water, raw water is purified through an apparatus for a pretreatment 6, an apparatus for producing primary pure water 7 and an apparatus for producing secondary pure water 8. The obtained ultrapure water is sent to the point of use. In the apparatus for a pretreatment, operations such as precipitation with coagulation, filtration with coagulation and floating with coagulation under an added pressure remove mainly substances causing turbidity in the raw water. In the apparatus for producing primary pure water, primary pure water having a content of total organic carbon (TOC) components of 2 ppb by weight or smaller is obtained by operations such as ion exchange, separation with a membrane and degassing. The obtained primary pure water is temporarily stored in a tank for primary pure water 9 and then sent to an apparatus for producing secondary pure water by a pump 10.

In the apparatus of the present embodiment, the apparatus for producing secondary pure water comprises a heat exchanger 11, an apparatus for the oxidizing treatment with ultraviolet light 12, an apparatus for decomposing hydrogen peroxide 13, an apparatus for removing dissolved oxygen 14, a polisher 15 and an apparatus for separating fine particles with a membrane 16. As the apparatus for the oxidizing treatment with ultraviolet light, an apparatus for irradiation with ultraviolet light which is equipped with a low voltage mercury lamp for irradiation with ultraviolet light of about 185 nm can be used. Organic carbon (TOC) components in the primary pure water are oxidized to form organic acids and further to carbon dioxide by the apparatus for the oxidizing treatment with ultraviolet light. Hydrogen peroxide is formed due to irradiation with ultraviolet light in an excessive amount by the apparatus for the oxidizing treatment with ultraviolet light.

In the apparatus of the present invention, it is preferable that the apparatus for decomposing hydrogen peroxide is disposed immediately after the apparatus for the oxidizing treatment with ultraviolet light in the apparatus for producing ultrapure water. The water treated at the apparatus for the oxidizing treatment with ultraviolet light 12 is sent to the apparatus for decomposing hydrogen peroxide 13 and brought into contact with the catalyst for decomposing hydrogen peroxide obtained by depositing nano-colloid particles of a metal of the platinum group to be supported on a support. Hydrogen peroxide in the water is decomposed by the reaction of 2H₂O₂→2H₂O+O₂. The process for bringing the water into contact with the catalyst for decomposing hydrogen peroxide is not particularly limited. It is preferable that the water is passed through an apparatus for decomposing hydrogen peroxide packed with the catalyst for decomposing hydrogen peroxide. As for the direction of flow of the water, any of the upward flow and the downward flow may be used. The downward flow is preferable since fluidization of the catalyst is prevented.

In the present invention, it is preferable that the water is passed through the catalyst for decomposing hydrogen peroxide at a flow rate such that the space velocity SV is 100 to 2,000 h⁻¹ and more preferably 500 to 1,500 h⁻¹. In the process of the present invention, the rate of decomposition of hydrogen peroxide is very great and, in general, it is not necessary that the space velocity SV is smaller than 100 h⁻¹. When the space velocity SV exceeds 2,000 h⁻¹, the loss of pressure due to passage of the water excessively increases, and there is the possibility that decomposition and removal of hydrogen peroxide becomes insufficient.

Since the nano-colloid particles of a metal of the platinum group supported on the anion exchange resin, which are used in the present invention, have a great specific surface area, the rate of decomposition of hydrogen peroxide is very great, and the space velocity of the passing water can be increased. Since the amount of the water passing through the apparatus is great relative to the amount of the catalyst, the effect of the metal eluted from the catalyst into the water for treatment can be made very small. The amount of the catalyst for decomposing hydrogen peroxide can be decreased, and the cost of the treatment can be decreased. Since hydrogen peroxide in the water is rapidly decomposed by bringing the water into contact with the nano-colloid particles of a metal of the platinum group supported on the anion exchange resin and does not affect the anion exchange resin, there is no possibility that anion exchange resin is invaded with hydrogen peroxide and organic carbon substances are eluted.

In the process of the present invention, it is preferable that the concentration of hydrogen peroxide in the water which has been treated by bringing the water into contact with the catalyst for decomposing hydrogen peroxide is 5 ppb by weight or smaller and more preferably 1 ppb or smaller. When the concentration of hydrogen peroxide in ultrapure water is 5 ppb by weight or smaller, treatments such as cleaning with the ultrapure water can be conducted without adverse effects on members of devices such as semiconductors and liquid crystals.

In the apparatus for removing hydrogen peroxide of the present invention, it is preferable that an apparatus for removing dissolved oxygen which is used for removing oxygen formed by decomposition of hydrogen peroxide is disposed after the apparatus for decomposing hydrogen peroxide. The apparatus for removing dissolved oxygen is not particularly limited. Examples of the apparatus for removing dissolved oxygen include an apparatus for degassing under a vacuum, an apparatus for degassing with nitrogen gas, an apparatus for degassing with a membrane and apparatus for deoxygenating with a catalyst. Among these apparatuses, the apparatus for degassing with a membrane and apparatus for deoxygenating with a catalyst are preferable. In the embodiment shown in FIG. 2, water treated in the apparatus for decomposing hydrogen peroxide 13 is sent to an apparatus for removing dissolved oxygen 14, and oxygen formed by decomposition of hydrogen peroxide is removed.

In the apparatus for degassing with a membrane, water is passed through one of chambers of a membrane, and the other chamber of the membrane is evacuated to a reduced pressure. Oxygen permeates through the membrane to the chamber under a reduced pressure and is removed. The membrane is a membrane which allows permeation of gasses such as oxygen, nitrogen, carbon dioxide and water vapor but does not allow permeation of liquid water. Examples of the membrane include silicone-based membranes, polytetrafluoroethylene-based membranes, polyolefin-based membranes and polyurethane-based membranes. It is preferable that the pressure in the apparatus for degassing with a membrane in the chamber under a reduced pressure is 5 to 10 kPa. Since some amount of water vapor permeates through the membrane to the chamber under a reduced pressure, it is preferable that a gas such as nitrogen is introduced through the chamber under a reduced pressure so that water is removed and decrease in the property of the membrane is prevented. When the pressure in the chamber under a reduced pressure is lower than 5 kPa, there is the possibility that the amount of water vapor permeating through the membrane is excessively great. When the pressure in the chamber under a reduced pressure exceeds 10 kPa, there is the possibility that the efficiency of removing dissolved oxygen decreases. It is preferable that the flow rate of the gas such as nitrogen is 5 to 25% by volume of the amount of the water passing through the apparatus. By using the apparatus for degassing with a membrane, carbon dioxide dissolved in water can be removed in combination with dissolved oxygen contained in the primary pure water and dissolved oxygen formed by decomposition of hydrogen peroxide.

In the present invention, when the apparatus for deoxygenating with a catalyst is used as the apparatus for removing dissolved oxygen, an apparatus packed with an anion exchange resin supporting platinum, palladium, a platinum/palladium alloy or a mixture of two or more these metals as the deoxygenating catalyst is preferable. For forming the metal supported on an anion exchange resin, an acidic solution of a metal compound such as hexachloroplatinic acid and palladium chloride is passed through a column packed with an anion exchange resin and, then, the metal can be formed from the metal compound by reduction by passing formaline or the like through the column. In the present invention, it is preferable that hydrogen is added to the deoxygenating catalyst. Although deoxygenation takes place when the deoxygenating catalyst comprising an anion exchange resin supporting platinum, palladium, a platinum/palladium alloy or a mixture of two or more of these metals contains hydrogen absorbed therein, dissolved oxygen can be more surely removed by the reaction of O₂+2H₂→2H₂O by adding hydrogen to the deoxygenating catalyst.

In the process of the present invention, it is preferable that the concentration of dissolved oxygen in the water obtained after the treatment of removing dissolved oxygen is 5 ppb by weight or smaller and more preferably 1 ppb by weight or smaller. When the concentration of dissolved oxygen in ultrapure water is 5 ppb by weight or smaller, treatments such as cleaning with the ultrapure water can be conducted without adverse effects on members of devices such as semiconductors and liquid crystals.

In the apparatus of the present invention, it is preferable that the apparatus for removing dissolved oxygen 14 is disposed before the polisher 15. As the polisher, a mixed bed apparatus for ion exchange of the non-regeneration type which is packed with a mixture of a strongly acidic cation exchange resin and a strongly basic anion exchange resin selected in accordance with the load of ions is preferable. Cations and anions in the water are completely removed by the mixed bed apparatus for ion exchange, and ultrapure water having an extremely small electric conductivity can be obtained. Since the treated water in which both of hydrogen peroxide and dissolved oxygen have been removed to extremely low concentrations by passing through the apparatus for decomposing hydrogen peroxide and the apparatus for removing dissolved oxygen is passed through the polisher, degradation of the ion exchange resin filling the polisher and elution of organic carbon (TOC) components from the ion exchange resin can be prevented.

In the embodiment shown in FIG. 2, the water which has been treated in the polisher 15 is passed through an apparatus for separating fine particles with a membrane 16. As the membrane for separating fine particles, for example, an ultrafiltration membrane can be used. Fine particles in the water such as fine particles derived from the ion exchange resin in the polisher can be removed by the apparatus for separating fine particles with a membrane, and high purity ultrapure water in which organic oxygen (TOC) components, hydrogen peroxide, dissolved oxygen, carbon dioxide, ionic substance and fine particles have been removed to a great degree can be obtained.

In conventional apparatuses for producing ultrapure water, a small amount of hydrogen peroxide formed in an apparatus for oxidizing treatment with ultraviolet light is decomposed with an ion exchange resin of the mixed bed type. Organic carbon (TOC) components from the ion exchange resin are mixed into the water, and the concentration of dissolved oxygen is increased due to the above phenomenon. In the process of the present invention and the apparatus of the present invention, hydrogen peroxide is removed with the catalyst for decomposing hydrogen peroxide. Dissolved oxygen formed by this treatment is removed by the apparatus for removing dissolved oxygen, and the treated water is passed through the polisher. Therefore, ultrapure water containing hydrogen peroxide and dissolved oxygen in extremely decreased amounts can be obtained.

### EXAMPLES

The present invention will be described more specifically with reference to examples in the following. However, the present invention is not limited to the examples.

In Examples and Comparative Examples, the concentration of hydrogen peroxide and the concentration of dissolved oxygen were measured in accordance with the following methods.

### (1) Concentration of Hydrogen Peroxide

A reagent for determining a small concentration of hydrogen peroxide was prepared by adding sodium sulfate (anhydrous) to 4.8 mg of phenolphthalein, 8 mg of copper sulfate (anhydrous) and 48 mg of sodium hydroxide so that the amount of the resultant mixture was adjusted at 10 g. The obtained reagent in an amount of 0.5 g was added to and dissolved into 10 ml of water for the measurement. After the resultant solution was left standing at the room temperature for 10 minutes, the absorbance of light of 552 nm was measured.

### (2) Concentration of Dissolved Oxygen

The concentration of dissolved oxygen was measured online using a meter for dissolved oxygen of the polarograph type [manufactured by ORBISPHERE LABORATORY Company, MOCA 3600].

### Example 1

Nano-colloid particles of platinum having an average diameter of 3.5 nm was deposited to be supported on a strongly basic anion exchange resin of the gel type in an amount of 0.07% by weight of the support, and a catalyst for decomposing hydrogen peroxide was prepared.

A column made of an acrylic resin was packed with 100 ml of the prepared catalyst for decomposing hydrogen peroxide, and ultrapure water containing 29.54 ppb by weight of hydrogen peroxide was passed through the column at SV=1,000 h⁻¹ in the downward direction. The concentration of hydrogen peroxide in the treated water discharged from the column was 0.38 ppb by weight, and the fraction of removed hydrogen peroxide was 98.7%.

Ultrapure water containing 29.5 ppb by weight of hydrogen peroxide was passed through a column packed with the same catalyst for decomposition of hydrogen peroxide at SV=200 h⁻¹, 400 h⁻¹, 600 h⁻¹, 800 h⁻¹, 1,500 h⁻¹ and 2,000 h⁻¹ in the downward direction. The fractions of removed hydrogen peroxide were 100.0%, 99.8%, 99.6%, 99.2%, 98.0% and 96.9%, respectively.

### Example 2

The same procedures as those conducted in Example 1 were conducted except that a catalyst in which nano-colloid particles of palladium having an average diameter of 3.5 nm was deposited to be supported on a strongly basic anion exchange resin in an amount of 0.07% by weight of the support was used and ultrapure water containing 29.32 ppb by weight was passed through the column.

At SV=1,000 h⁻¹, the concentration of hydrogen peroxide in the treated water discharged from the column was 0.50 ppb by weight, and the fraction of removed hydrogen peroxide was 98.3%. At SV=200 h⁻¹, 400 h⁻¹, 600 h⁻¹, 800 h⁻¹, 1,500 h⁻¹ and 2,000 h⁻¹, the fractions of removed hydrogen peroxide were 100.0%, 99.4%, 99.0%, 98.7%, 97.4% and 96.7%, respectively.

### Comparative Example 1

A strongly basic anion exchange resin of the gel type was dipped into a solution of sodium platinate. Platinum was supported on the surface of the resin while reduction was conducted with formaldehyde, and a catalyst for decomposing hydrogen peroxide was prepared. The amount of supported platinum in the obtained catalyst was 0.75% by weight.

A column made of an acrylic resin was packed with 100 ml of the catalyst for decomposing hydrogen peroxide prepared above, and the same procedures as those conducted in Example 1 were conducted using ultrapure water containing 28.75 ppb by weight of hydrogen peroxide.

At SV=1,000 h⁻¹, the concentration of hydrogen peroxide in the treated water discharged from the column was 1.50 ppb by weight, and the fraction of removed hydrogen peroxide was 94.8%. At SV=200 h⁻¹, 400 h⁻¹, 600 h⁻¹, 800 h⁻¹, 1,500 h⁻¹ and 2,000 h⁻¹, the fractions of removed hydrogen peroxide were 100.0%, 98.8%, 96.4%, 89.2% and 8.28%, respectively.

### Comparative Example 2

The same procedures as those conducted in Example 1 were conducted except that a column made of an acrylic resin was packed with 100 ml of a strongly basic anion exchange resin of the gel type supporting palladium [manufactured by LANXESS Co., Ltd., the trade name: LEWATIT K7333] and ultrapure water containing 28.93 ppb by weight of hydrogen peroxide was used.

At SV=1,000 h⁻¹, the concentration of hydrogen peroxide in the treated water discharged from the column was 2.00 ppb by weight, and the fraction of removed hydrogen peroxide was 93.1%. At SV=200 h⁻¹, 400 h⁻¹, 600 h⁻¹, 800 h⁻¹, 1,500 h⁻¹ and 2,000 h⁻¹, the fractions of removed hydrogen peroxide were 100.0%, 98.7%, 96.4%, 85.9% and 79.5%, respectively.

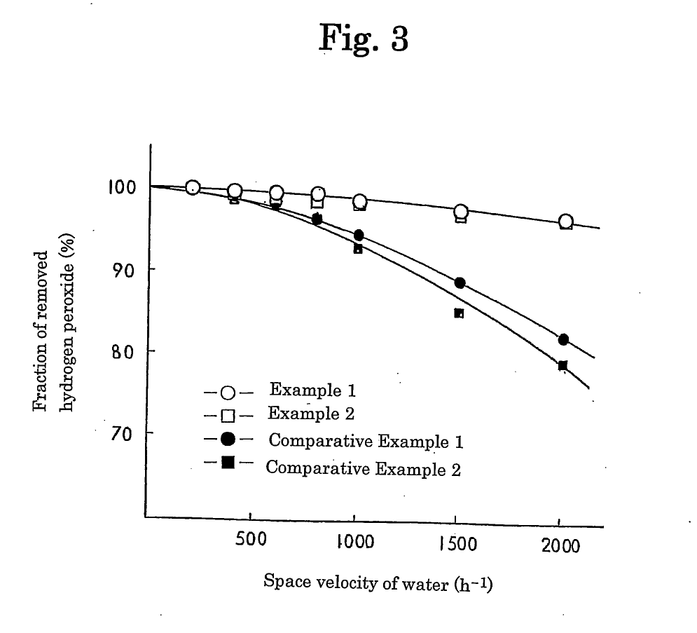

The results of Examples 1 and 2 and Comparative Examples 1 and 2 are shown in Table 1 and FIG. 3.

TABLE 1

| | |
|---|---|
| Concentration of | |
| hydrogen peroxide | Fraction of removed |
| (ppb) | hydrogen peroxide |

| | inlet | outlet | (%) |
|---|---|---|---|
| Example 1 | 29.54 | 0.38 | 98.7 |
| Example 2 | 29.32 | 0.50 | 98.3 |
| Comparative | 28.75 | 1.50 | 94.8 |
| Example 1 | | | |
| Comparative | 28.93 | 2.00 | 93.1 |
| Example 2 | | | |

As shown in Table 1 and FIG. 3, in Example 1 in which the catalyst obtained by depositing nano-colloid particles of platinum to be supported on a support was used and Example 2 in which the obtained by depositing nano-colloid particles of palladium to be supported on a support was used, greater fractions of hydrogen peroxide were removed than those in Comparative Example 1 in which the conventional catalyst containing supported platinum was used and in Comparative Example 2 in which the conventional catalyst containing supported palladium was used despite the amounts of the catalysts containing a supported metal in Examples 1 and 2 were smaller than those in Comparative Examples 1 and 2. The greater the rate of passing water, the greater the difference in the fraction of removed hydrogen peroxide between Examples 1 and 2 and Comparative Examples 1 and 2. Thus, it was shown that water containing hydrogen peroxide could be treated more efficiently using a smaller amount of platinum or palladium in accordance with the process of the present invention.

### Example 3

A vessel packed with 10 liters of a catalyst for decomposing hydrogen peroxide obtained by depositing nano-colloid particles of platinum having an average diameter of 3.5 nm to be supported on a strongly basic anion exchange resin of the gel type in an amount of 0.07% by weight of the support was connected to the outlet of an apparatus for the oxidizing treatment with ultraviolet light of an apparatus for producing ultrapure water. An apparatus for degassing with a membrane, a mixed bed vessel filled with an anion exchange resin and an apparatus for ultrafiltration were connected after the vessel packed with the catalyst. Ultrapure water was produced at a flow rate of 10 m³/h using the prepared apparatus.

The concentration of hydrogen peroxide in the water flowing into the vessel packed with the catalyst for decomposing hydrogen peroxide was 15.78 ppb by weight, and the concentration of hydrogen peroxide in the treated water flowing out of the vessel was 0.14 ppb by weight. The fraction of removed hydrogen peroxide was 99.1%. The concentration of dissolved oxygen in ultrapure water flowing out of the apparatus for ultrafiltration was 0.56 ppb by weight.

### Comparative Example 3

A vessel packed with 10 liters of the catalyst for decomposing hydrogen peroxide prepared in Comparative Example 1 was connected to the outlet of an apparatus for the oxidizing treatment with ultraviolet light of an apparatus for producing ultrapure water. An apparatus for degassing with a membrane, a mixed bed vessel filled with an anion exchange resin and an apparatus for ultrafiltration were connected after the vessel packed with the catalyst. Ultrapure water was produced at a flow rate of 10 m³/h using the prepared apparatus.

The concentration of hydrogen peroxide in the water flowing into the vessel packed with the catalyst for decomposing hydrogen peroxide was 14.99 ppb by weight, and the concentration of hydrogen peroxide in the treated water flowing out of the vessel was 0.82 ppb by weight. The fraction of removed hydrogen peroxide was 94.5%. The concentration of dissolved oxygen in ultrapure water flowing out of the apparatus for ultrafiltration was 0.79 ppb by weight.

### Comparative Example 4

A vessel packed with 10 liters of a strongly basic anion exchange resin of the gel type supporting palladium [manufactured by LANXESS Co., Ltd., the trade name: LEWATITK 7333] was connected to the outlet of an apparatus for the oxidizing treatment with ultraviolet light of an apparatus for producing ultrapure water. An apparatus for degassing with a membrane, a mixed bed vessel filled with an anion exchange resin and an apparatus for ultrafiltration were connected after the vessel packed with the catalyst. Ultrapure water was produced at a flow rate of 10 m³/h using the prepared apparatus.

The concentration of hydrogen peroxide in the water flowing into the vessel packed with the catalyst for decomposing hydrogen peroxide was 15.01 ppb by weight, and the concentration of hydrogen peroxide in the treated water flowing out of the vessel was 1.10 ppb by weight. The fraction of removed hydrogen peroxide was 92.7%. The concentration of dissolved oxygen in ultrapure water flowing out of the apparatus for ultrafiltration was 0.79 ppb by weight.

### Comparative Example 5

After an apparatus for the oxidizing treatment with ultraviolet light of an apparatus for producing ultrapure water, an empty vessel containing no catalyst, an apparatus for degassing with a membrane, a mixed bed vessel filled with an anion exchange resin and an apparatus for ultrafiltration were connected. Ultrapure water was produced at a flow rate of 10 m³/h using the prepared apparatus.

The concentration of hydrogen peroxide in the water flowing into the empty vessel was 15.01 ppb by weight, and the concentration of hydrogen peroxide in the water flowing out of the empty vessel was 14.98 ppb by weight. The fraction of removed hydrogen peroxide was 0.2%. The concentration of dissolved oxygen in ultrapure, water flowing out of the apparatus for ultrafiltration was 0.98 ppb by weight.

The results of Example 3 and Comparative Examples 3 to 5 are shown in Table 2.

TABLE 2

| | | | Fraction of | Concentration of |
|---|---|---|---|---|
| | Concentration of | | removed | dissolved oxygen |
| | hydrogen peroxide | | hydrogen | in ultrapure |
| | (ppb) | | peroxide | water |
| | inlet | outlet | (%) | (ppb) |
| Example 3 | 15.78 | 0.14 | 99.1 | 0.56 |
| Comparative | 14.99 | 0.82 | 94.5 | 0.79 |
| Example 3 | | | | |
| Comparative | 15.01 | 1.10 | 92.7 | 0.79 |
| Example 4 | | | | |
| Comparative | 15.01 | 14.98 | 0.2 | 0.98 |
| Example 5 | | | | |

As shown in Table 2, in Example 3 in which the vessel packed with the catalyst for decomposing hydrogen peroxide obtained by depositing nano-colloid particles of platinum to be supported on the strongly basic anion exchange resin was connected to the outlet of the apparatus for the oxidation treatment with ultraviolet light and hydrogen peroxide was decomposed, hydrogen peroxide was removed with a greater fraction of removed hydrogen peroxide than those in Comparative Example 3 in which the conventional catalyst containing supported platinum was used and Comparative Example 4 in which the conventional catalyst containing supported palladium was used despite the amount of the catalyst containing a supported metal in Example 3 was smaller than those in Comparative Examples 3 and 4. In Example 3 in which the fraction of removed hydrogen peroxide was greater, the concentration of dissolved oxygen in the ultrapure water was smaller than those in Comparative Examples 3 and 4 in which the fraction of removed hydrogen peroxide was smaller. This result is considered to be obtained due to the difference between the case where, after oxygen formed during decomposition of hydrogen oxide had been removed with a membrane for degassing, water was passed through the mixed bed vessel packed with the ion exchange resin under the condition of a small concentration of hydrogen peroxide and the case where water was passed through the mixed bed vessel packed with the ion exchange resin under the condition of a great concentration of hydrogen peroxide. In other words, hydrogen peroxide left remaining in the treated water was decomposed by the reaction with the resin in the mixed bed vessel packed with the ion exchange resin although the amount was very small, and dissolved oxygen is formed. Since the dissolved oxygen thus formed was left remaining without being removed, the greater the concentration of hydrogen peroxide in the treated water, the greater the concentration of dissolved oxygen in the ultrapure water at the point of use. In accordance with the process of the present invention, the concentration of residual hydrogen peroxide in the treated water is decreased by increasing the fraction of removed hydrogen peroxide in the water for treatment, and the concentration of dissolved oxygen in the ultrapure water is also decreased.

### INDUSTRIAL APPLICABILITY

In accordance with the process of the present invention and by using the apparatus of the present invention, hydrogen peroxide in water for treatment can be rapidly and surely removed with a small amount of the catalyst for decomposing hydrogen peroxide. In particular, hydrogen peroxide in ultrapure water in an apparatus for producing ultrapure water used in industries handling electronic materials such as semiconductors and liquid crystals can be removed, and ultrapure water also having a small concentration of dissolved oxygen can be produced efficiently.

1-11. (canceled)

12. A process for removing hydrogen peroxide in water which comprises bringing water for treatment containing hydrogen peroxide into contact with a catalyst for decomposing hydrogen peroxide obtained by depositing nano-colloid particles of a metal of a platinum group which have an average diameter of 1 to 50 nm to be supported on a support.

13. The process for removing hydrogen peroxide according to claim 12, wherein the metal of a platinum group is platinum, palladium or a platinum/palladium alloy, which is used singly or as a mixture of two or more.

14. The process for removing hydrogen peroxide according to claim 12, wherein the support which supports the nano-colloid particles of a metal of a platinum group is an anion exchange resin.

15. The process for removing hydrogen peroxide according to claim 12, wherein the water for treatment containing hydrogen peroxide is water containing hydrogen peroxide in an apparatus for producing ultrapure water.

16. The process for removing hydrogen peroxide according to claim 15, wherein the water containing hydrogen peroxide in an apparatus for producing ultrapure water is water discharged from an apparatus for oxidizing treatment with ultraviolet light of the apparatus for producing ultrapure water.

17. The process for removing hydrogen peroxide according to claim 12, wherein the water for treatment is brought into contact with the catalyst for decomposing hydrogen peroxide obtained by depositing nano-colloid particles of a metal of a platinum group to be supported on a support at a flow rate such that a space velocity SV is 100 to 2,000 h⁻¹.

18. The process for removing hydrogen peroxide according to claim 12, wherein a concentration of hydrogen peroxide in treated water is 5 ppb by weight or smaller.

19. The process for removing hydrogen peroxide according to claim 12, wherein dissolved oxygen formed by decomposition of hydrogen peroxide is removed by treatment of degassing with a membrane or by treatment with a deoxygenation catalyst in a later step.

20. The process for removing hydrogen peroxide according to claim 19, wherein hydrogen is added to the deoxygenation catalyst.

21. The process for removing hydrogen peroxide according to claim 19, wherein a concentration of dissolved oxygen in treated water obtained after the treatment for removing dissolved oxygen is 5 ppb by weight or smaller.

22. The process for removing hydrogen peroxide according to claim 14, wherein the amount of the nano-colloid particles of the metal of the platinum group supported on the anion exchange resin is 0.01 to 0.2% by weight.

23. An apparatus for removing hydrogen peroxide which comprises an apparatus for decomposing hydrogen peroxide packed with a catalyst obtained by depositing nano-colloid particles of a metal of a platinum group which have an average diameter of 1 to 50 nm to be supported on a support, a means for supplying water which supplies water for treatment containing hydrogen peroxide to the apparatus and a means for discharging water which discharges water from the apparatus after being brought into contact with the catalyst.

24. An apparatus for removing hydrogen peroxide described in claim 23, wherein the metal of a platinum group is platinum, palladium or a platinum/palladium alloy, which is used singly or as a mixture of two or more.

25. An apparatus for removing hydrogen peroxide described in claim 23, wherein the support which supports the nano-colloid particles of a metal of a platinum group is an anion exchange resin.

26. An apparatus for removing hydrogen peroxide described in claim 23, wherein the apparatus for decomposing hydrogen peroxide is disposed immediately after an apparatus for oxidizing treatment with ultraviolet light of an apparatus for producing ultrapure water.

27. An apparatus for removing hydrogen peroxide described in claim 23, wherein an apparatus for removing dissolved oxygen which removes oxygen formed by decomposition of hydrogen peroxide is disposed after the apparatus for decomposing hydrogen peroxide.

28. An apparatus for removing hydrogen peroxide described in claim 27, wherein the apparatus for removing dissolved oxygen is an apparatus for degassing with a membrane or an apparatus for deoxygenating with a catalyst.

29. An apparatus for removing hydrogen peroxide described in claim 28, wherein the apparatus for deoxygenating with catalyst is an apparatus packed with an anion exchange resin supporting platinum, palladium or a platinum/palladium alloy, which is used singly or as a mixture of two or more.

30. An apparatus for removing hydrogen peroxide described in claim 27, wherein the apparatus for removing dissolved oxygen is disposed before a polisher.
